(19) United States
(12) Patent Application Publication
(10) Pub. No.: US 2019/0377474 A1
(43) Pub. Date: Dec. 12, 2019

(54) SYSTEMS AND METHODS FOR A MIXED REALITY USER INTERFACE

(71) Applicant: FactualVR, Inc., Jersey City, NJ (US)

(72) Inventor: EDUARDO NEETER, Jersey City, NJ (US)

(73) Assignee: FactualVR, Inc., Jersey City, NJ (US)

(21) Appl. No.: 16/204,765

(22) Filed: Nov. 29, 2018

Related U.S. Application Data
(60) Provisional application No. 62/681,178, filed on Jun. 6, 2018.

(51) Int. Cl. G06F 3/0481; G06T 19/00; G02B 27/01; G06F 3/0484

(52) U.S. Cl. CPC G06F 3/04815; G06T 19/006; G02B 2027/0138; G06F 3/04847; G02B 27/017

(57) ABSTRACT

Systems and methods for a mixed reality user interface are provided. The systems and methods relate to equipment and an interface that a user can employ to interact with a real or a virtual environment. The equipment includes a head device, a torso device, a waist device, and a hands device(s). The interface includes user interface elements, referred to as “widgets”, that are attachable and removable from a grid of user interface space locations, referred to as “magnets”. The user is able to use the widgets to interact with the virtual environment.

### CROSS-REFERENCE TO RELATED APPLICATIONS

This application claims the benefit of U.S. Provisional Patent Application No. 62/681,178, filed on Jun. 6, 2018, the entire disclosure of which is expressly incorporated herein by reference.

### BACKGROUND

### Technical Field

The present disclosure relates generally to the field of virtual reality. More specifically, the present disclosure relates to systems and methods for a mixed reality user interface.

### Related Art

Virtual reality technology is becoming more prevalent in various fields, such as those regarding investigations and analytics. Using a VR device, such as a head mounted display (“HMD”), a user can be immersed in a virtual environment that is created based on real world sites and artificially-created objects. The user can use this virtual environment as a tool to experience a scene.

Current systems, however, are limited in the tools and capabilities offered. For example, modern virtual reality systems allow for very limited interaction between the user and the objects seen in a head up display (“HUD”) of the HMD. Further, modern virtual reality system lack the rich input capabilities an sensors available in the real world, such as voice command, eye track, 3D scanning, night vision, etc. As such, the ability to provide a user with advanced sensors and capabilities in a virtual reality environment is a powerful tool that can be used in investigations, medicine, combat, search and rescue, and other fields. Accordingly, the systems and methods disclosed herein solve these and other needs for a advanced mixed-reality user interface.

### SUMMARY

This present disclosure relates to systems and methods for a mixed reality user interface. Specifically, the systems and methods relate to equipment and an interface that a user can employ to interact with a real or a virtual environment. The equipment includes a head device, a torso device, a waist device, and a hands device(s). The interface includes user interface elements, referred to as “widgets”, that are attachable and removable from a grid of user interface space locations, referred to as “magnets”. The user is able to use the widgets to interact with the virtual environment.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating a user interacting with widgets in a virtual reality environment;

FIG. 2 is a diagram illustrating magnet grids seen by a user;

FIG. 3 is a diagram illustrating a helmet's grid and a vest's grid;

FIG. 4 is a diagram illustrating the six values;

FIG. 5 is a diagram illustrating a highlighted group of magnets;

FIGS. 6A-6E are diagrams illustrating using and interacting with different widgets and the menu of buttons on a widget;

FIG. 7 is a flowchart illustrating the process step being carried out by the user to interact with a widget;

FIG. 8 is a diagram illustrating an ultra-view tool;

FIGS. 9A and 9B are diagrams illustrating an example of a foot tracker tool and types of foot tracker tools;

FIGS. 10A and 10B are diagrams illustrating how foot tracers are perceived;

FIGS. 11A and 11B are diagrams illustrating a navigation tool;

FIGS. 12A-14 are diagrams illustrating a mini map tool;

FIG. 15 is a diagram illustrating a video feed tool;

FIG. 16-17B are diagrams illustrating examples of a commander's grid;

FIG. 18 is a diagram illustrating collaboration between a commander and an operator; and

FIG. 19 is a diagram illustrating sample hardware components on which the system of the present disclosure could be implemented.

### DETAILED DESCRIPTION

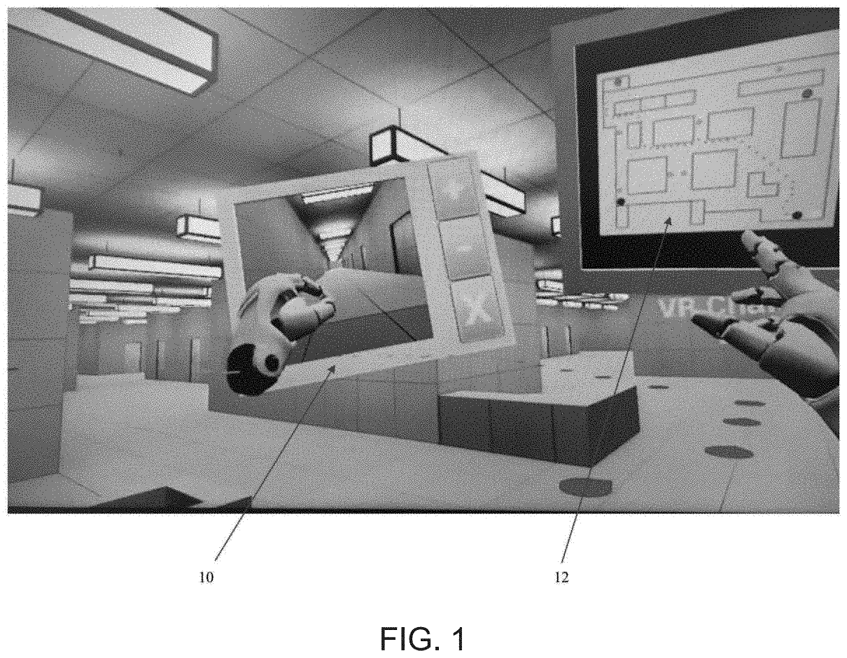

The present disclosure relates to computer modeling systems and methods for a mixed reality user interface, as described in detail below in connection with FIGS. 1-19.

The embodiments below will be related to a virtual reality system. In particular, the embodiments below will discuss systems and methods for arranging and interacting with user interface (“UI”) elements and with a virtual environment. The UI elements, which will be referred to as “widgets”, will persist relative to a user's head, torso, and waist, and will be attachable and removable from UI space locations. The widgets (or tools) are objects that the user can interact with (via, for example, a hand gesture(s), a voice command(s), an eye command(s), a controller(s), a sensor(s), etc.) in order to display and control information. For example, a widget can include videos, floorplans, tools, sensors, biometrics, etc., as well as defined areas where the user can perform hand gestures. FIG. 1 is an illustration showing a user interacting with a first widget 10 and a second widget 12 in a virtual reality environment. The widgets will be discussed in more detail below. The structure of the disclosure will discuss the user equipment, the user interface, the tools of the interface, and use of the system in operational scenarios.

### User Equipment

A user's uniform includes equipment that is worn or attached to different parts of the user's body. The equipment can be worn or attached to the user's head (head device), torso (torso device), hands (hands device), waist (waist device), etc. The head device can include a head mounted display (“HMD”), virtual reality googles, smart glasses, etc. The embodiments below will be related to a HMD. However, it should be understood that any reference to the HMD is only by way of example and the systems, methods and embodiments discussed throughout this disclosure can be applied to any head related device, including but not limited to the example listed above.

The HMD displays to the user a live view (e.g., real world), a live feed from a source, a virtual reality view, an augmented reality, a mixed-reality (e.g., a combination of real world and augmented reality/virtual reality), or any combination thereof. The HMD can be fitted with one or more cameras and/or sensors. The cameras include a live feed camera, a night vision camera, a thermal camera, an infrared camera, a 3D scanning camera, etc. The sensors include heat sensors, chemical sensors, humidity sensors, pressure sensors, audio microphones, speakers, depth sensors, or any other sensors capable of determining or gathering data. The cameras and sensors collect data from the user's location. The collected data can be transmitted by the HMD to a further user, a server, a computer system, a mobile phone, etc. The HMD can transmit the collected data via a wired or wireless connection, including but not limited to, a USB connection, a cellular connection, a WiFi connection, a Bluetooth connection, etc. The collected data can be live streamed for immediate use, or stored for later use. For a first example, a user can transmit a live view from a camera on the user's HMD to a further user, where the further user can view the user's point of view on their HMD. For a second example, the user can record metrics from a sensor, and transmit the recorded metrics to a server for future use.

The HMD can further include user related cameras/sensors and software. For example, the HMD can include an eye tracking sensors, a facial expression tracking sensor, a user pointed-to camera (e.g., for “face to face” communication between the user and one or more further users), etc. It should be understood that the HMD allows the user to freely move the head in any direction, and the HMD will recognize the movement and adjust the virtual environment.

The torso device includes any type of wearable device that can track the user's torso relative to a position of the HMD. For example, the torso equipment can include a piece of clothing (e.g., shirt, vest/bulletproof vest, strap, etc.) that includes sensor(s). The sensors can be attached or embedded in the torso device.

The hands device can include a wrist or arm device (e.g., a watch, a smartwatch, a band, etc.), a finger device (e.g., a ring), a hand device (e.g., gloves), a joystick, or any other hand/wrist/arm wearable or holdable. The hands device can include sensors that indicate location, movement, a user command, etc. Specifically, the hands device allows the user to use his hands as an input device, by capturing hand movements, finger movements, and overall hand gestures. For example, a user command can be executed by touching two fingers together with a glove, pressing a button on the joystick, or moving a hand in a direction, etc.

In another example, a user's hands can be tracked by one or more sensors in the HMD, by one or more sensors in the torso device, or a combination of sensors from the HMD and the torso device. This allows for a user's hands to be tracked without the user wearing the hands device.

The waist device includes any type of wearable device that can sense track the user's waist relative to a position of the HMD. For example, the waist device can be a belt, a sash, an attached sensor(s), etc. The waist device can be an extension of tracking the user's torso. The area of the user's torso and the area of the user's waist are differentiated to provide different interpretation to the user's gestures interacting with virtual elements placed in each area (e.g., grid). This will be explained in greater detail below.

### User Interface Area

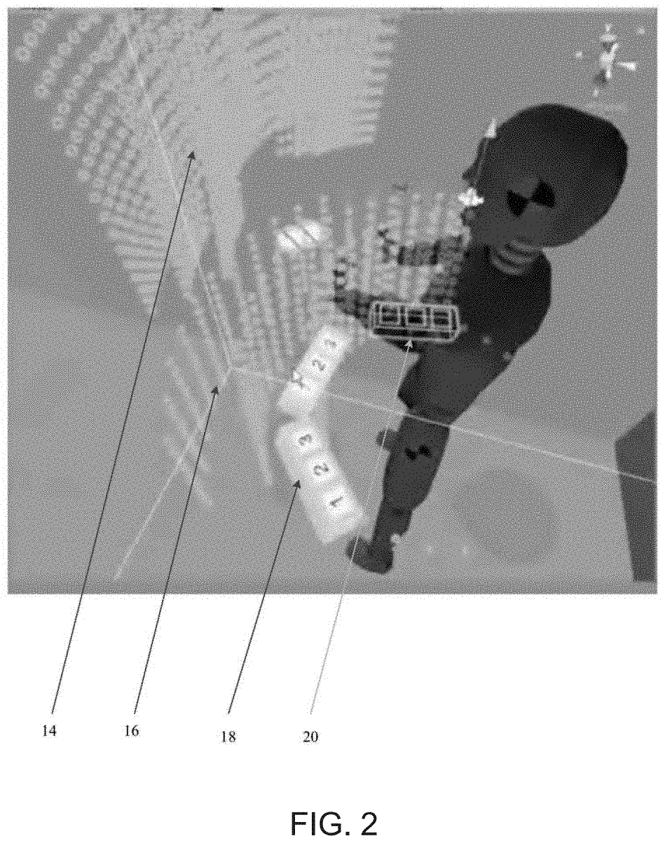

A UI area is a visual environment seen by the user. The UI area can be seen in the virtual space, in the real space, or a combination of both (e.g., augmented reality). The UI area is seen by the user via the HMD. Each user equipment (e.g., HMD, torso device, etc.) can have its own UI area. The UI area can include a grid of “magnets”. FIG. 2 is an illustration of magnet grids placed around or next to the user. Specifically, magnet grid 14 is a helmet (e.g., HMD) grid, magnet grid 16 is a torso grid or a vest's grid, magnet grid 18 is a waist grid, and magnet grid 20 is a hand/arm grid. The magnets serve as a point of reference for the grids (e.g., the helmet grid, the torso grid, etc.) to provide positional information relating to where a widget (e.g., a UI element) can attach. This allows the user to know which area the widget will attach to. The user can attach different widgets to any magnet, to a group of magnets, or float between two or more magnets on any grid. Again, the widgets are objects that the user can interact with in order to display and control information, such as videos, floorplans, tools, sensors, evidence, defined areas where the user can perform hand gestures, etc. The defined areas can, for example, be represented by red cubes attached to the helmet grid, torso, waist grid, etc. One or multiple areas can be defined and attached to a grid. Once the user's hand interacts (collide) with any of the defined areas, the system will read the hand gesture and interpret/act on the hand gesture. The widgets can be grab-able, place-able, scale-able, interactable, squish-able (e.g., buttons). The widgets can also have sub-classes, such as a representation of objects, people, etc. in a mini-map.

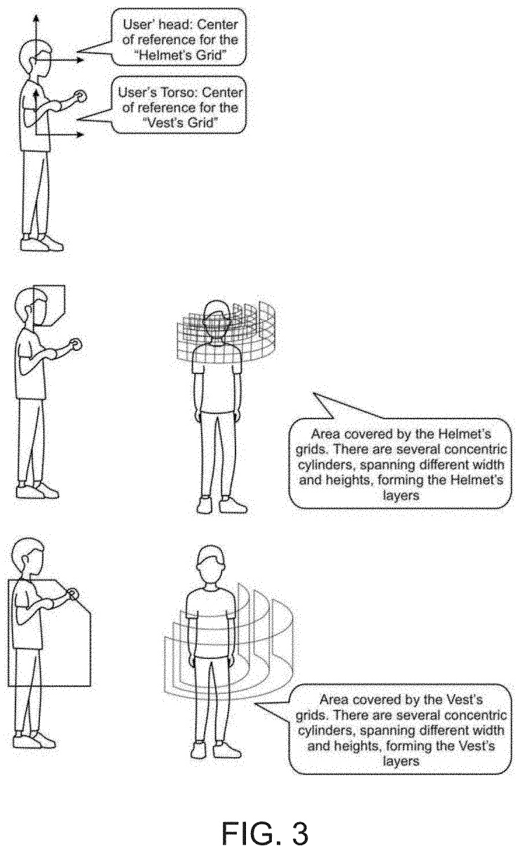

The magnets can be colored to aid the user in visualizing the location of a widget. In a first example, each grid has its own color. In a second example, a grid has multiple colored magnets. The colors can represent a type or class of widget (e.g., video feeds, evidence, tools, etc.). FIG. 3 is an illustration showing a helmet's grid and a vest's grid, as can be seen by the user.

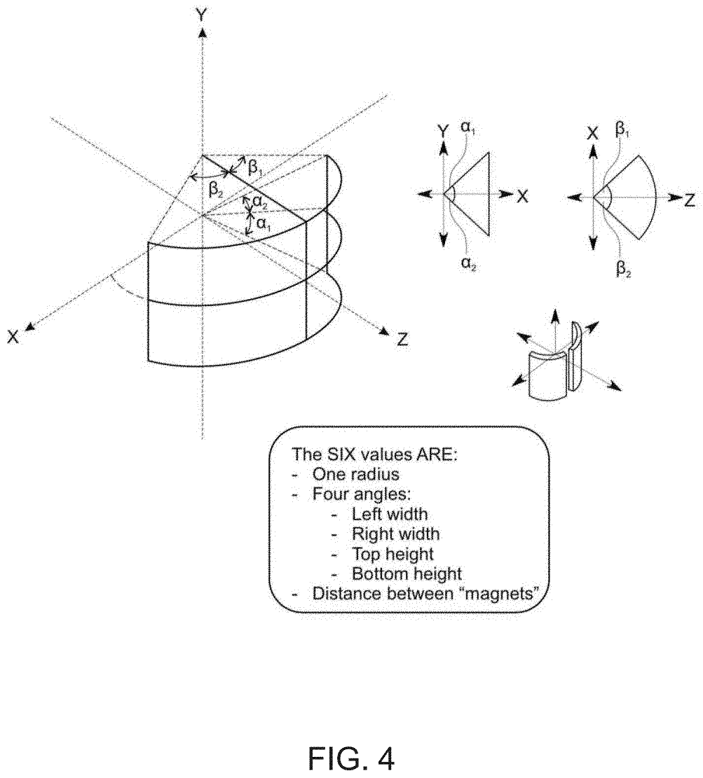

A grid can be defined in multiple, different ways. For example, a helmet grid can be defined using a first set of parameters and attributes and a torso grid can be defined using a second set of parameters and attributes. In an example, a grid is defined by six values and a parent object (e.g., a body part.) The six values include a radius, a left width angle, a right width angle, a top height angle, a bottom height angle, and a distance between the magnets. FIG. 4 is an illustration showing the six values.

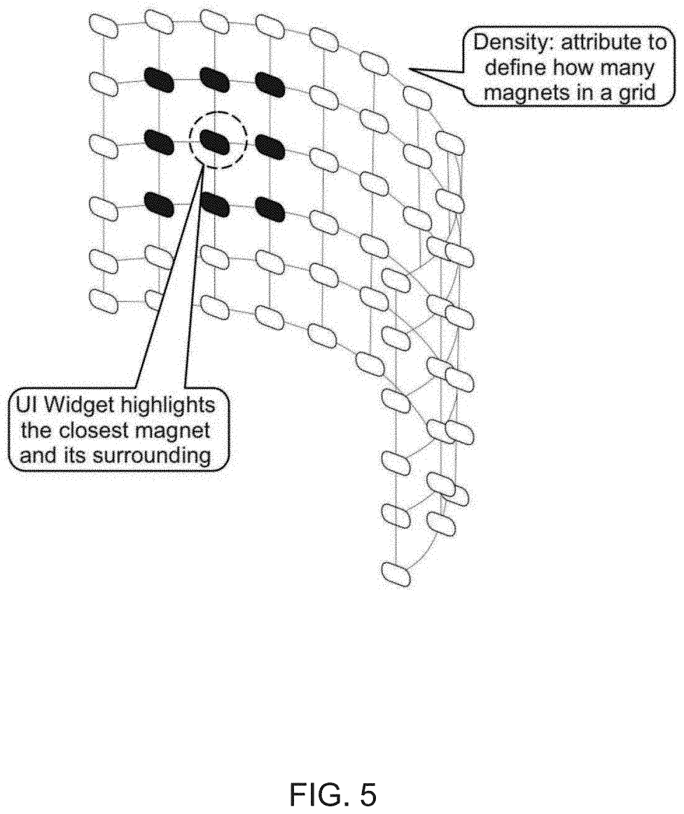

In a first embodiment, the user selects a widget by using the hands device. The user can, for example use a glove device to hover over a widget and pinch his fingers to select and drag the desired widget. When hovering a widget over a grid, one or more magnets can be highlighted. The highlighting functions as a visual aid to the user. In a second embodiment, the user can select a widget by looking at a widget and executing a command (e.g., blinking, tapping two fingers together, a verbal command, etc.). FIG. 5 is an illustration showing a highlighted group of magnets in an area of a grid that a UI widget is about to attach to. This provides the user with a visual aid regarding which grid (e.g., helmet grid, torso grid, etc.) the widget is about to attach to.

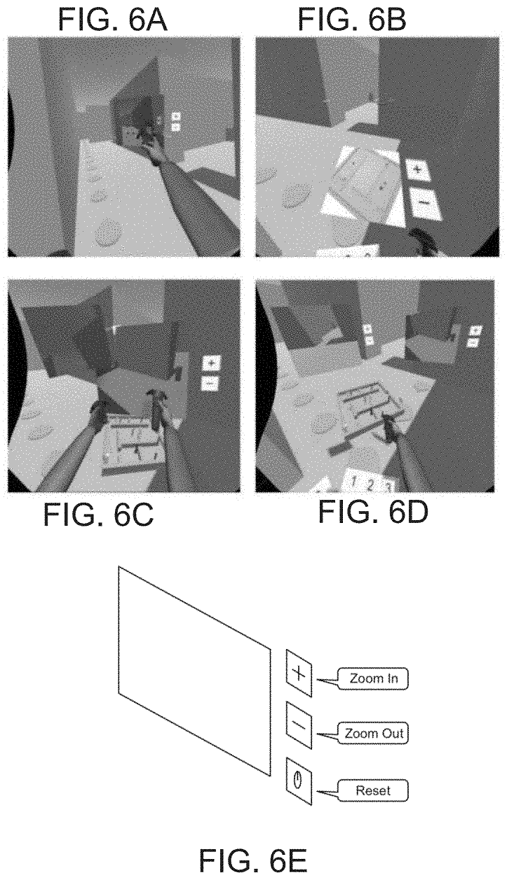

FIGS. 6A-6D show a user using and interacting with different widgets (e.g., different floorplans, video feeds, etc.). Each widget can include a menu of buttons. The buttons include a zoom in/out function, a reset function, a close function, a send function, a draw function, etc. FIG. 6E is an illustration showing an example of a menu of buttons on a widget. Each widget can have its own unique menu with buttons tailored to the function of the widget.

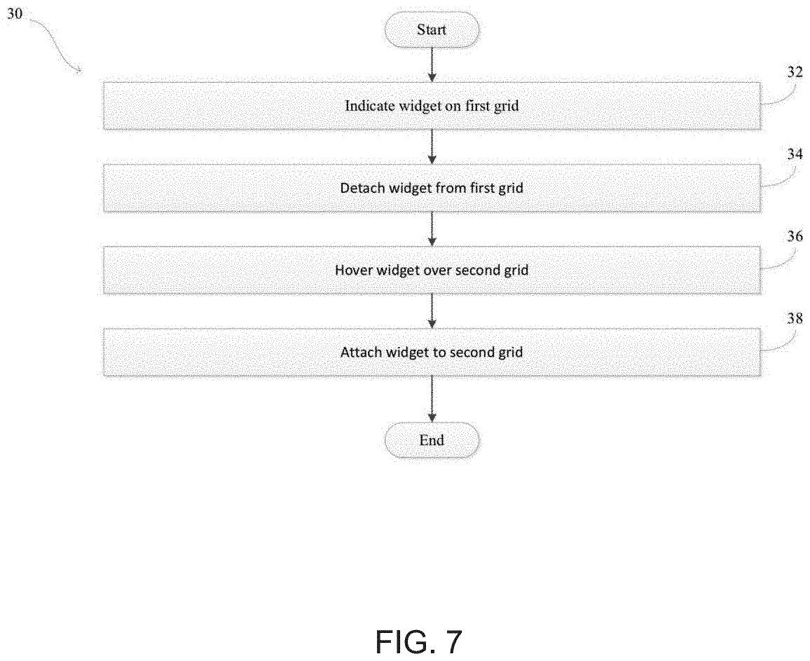

FIG. 7 is a flowchart illustrating the process steps being carried out by the user to interact with a widget, indicated generally at method 30. In step 32, the user indicates a widget on a grid (e.g., a helmet grid). The user can indicate the widget by looking at the widget, hovering a hand over the widget, moving a curser over the widget, using a voice command, etc. In step 34, the user detaches the widget from the first grid. For example, the user can detach the widget via a motion, a button, a voice command, etc. In step 36, the user moves the widget and hovers the widget over a second grid (e.g., a torso grid). In step 38, the user attaches the widget to the second grid.

### Tools and Widgets

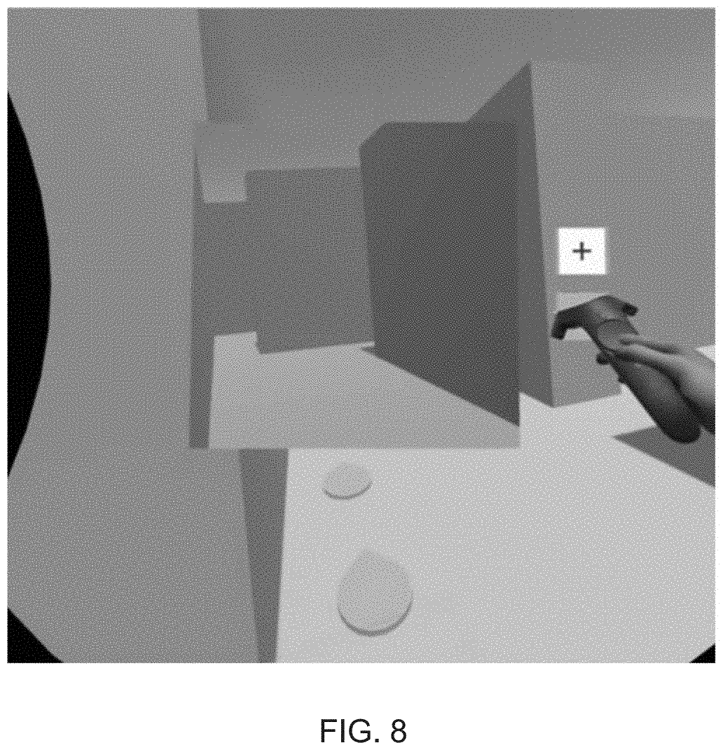

A tool is a mechanism used in the virtual environment. Tools can be widgets or tools can be inherent to a virtual environment. Tools and widgets can be part of a virtual toolkit available to the user. FIG. 8 is an illustration showing an example of an ultra-view tool. The ultra-view tool can be a camera view placed in from of the user's view. The camera view can be a zoomed view, a night vision view, a thermal vision view, etc.

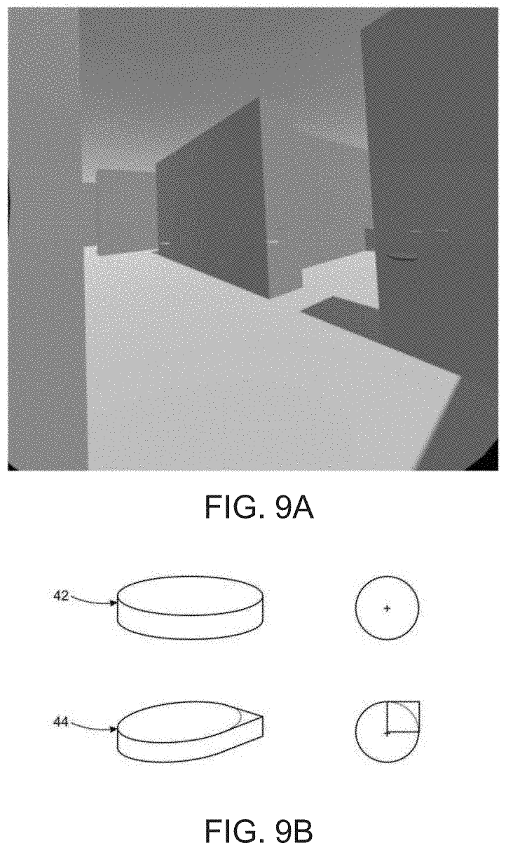

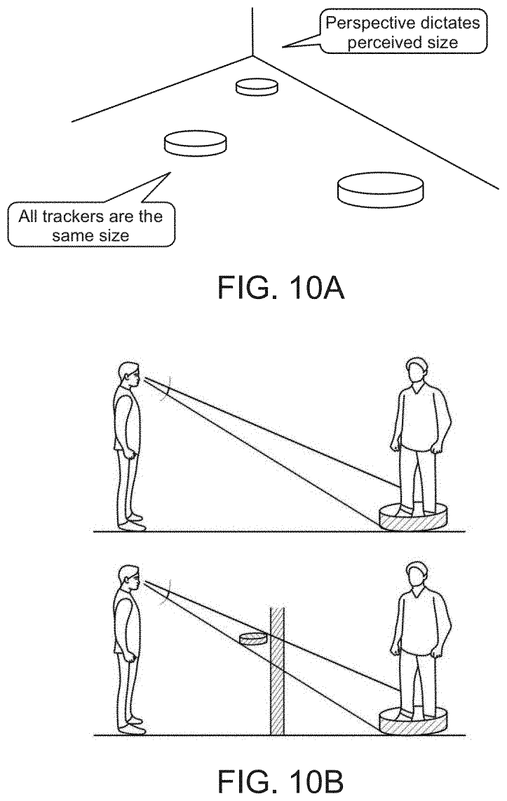

FIG. 9A is an illustration showing an example of a foot tracker tool. The foot tracker is a locater device placed on the floor. The foot tracker can be used to indicate different types of objects. For example, a foot tracker can indicate a user's partner, a kidnapper, a victim, a hazard, an exit, etc. Foot trackers for different objects can be shown in different colors. Foot trackers can be seen through a wall(s) in the virtual environment. Foot trackers can further show an orientation. For example, the orientation can indicate which way an object is oriented, which way person is looking or facing, etc. FIG. 9B is an illustration of two types of foot trackers. Specifically, foot tracker 42 is a basic foot tracker and foot tracker 44 is an orientation foot tracker. FIG. 10A is an illustration showing foot trackers being perceived as the same size. It should be noted that the foot trackers can be of the same absolute size, and the relative size can be perceived differently due to the effect of the perspective and the distance between the user and the location of the object (represented by the foot tracker). This can allow the user to discern the relative distance to the object by quickly looking at the foot tracker and perceiving its relative size. FIG. 10B is an illustration showing foot trackers being perceived through a wall. Specifically, FIG. 10B illustrates that when a foot tracker is rendered in front of a wall (to create the illusion that the foot tracker can be seen “through” the wall) the relative size of how the foot tracker is seen by the user preserves the relative size. This causes a desired impression in the user to estimate the relative distance of the object based on the relative size of the foot tracker observed.

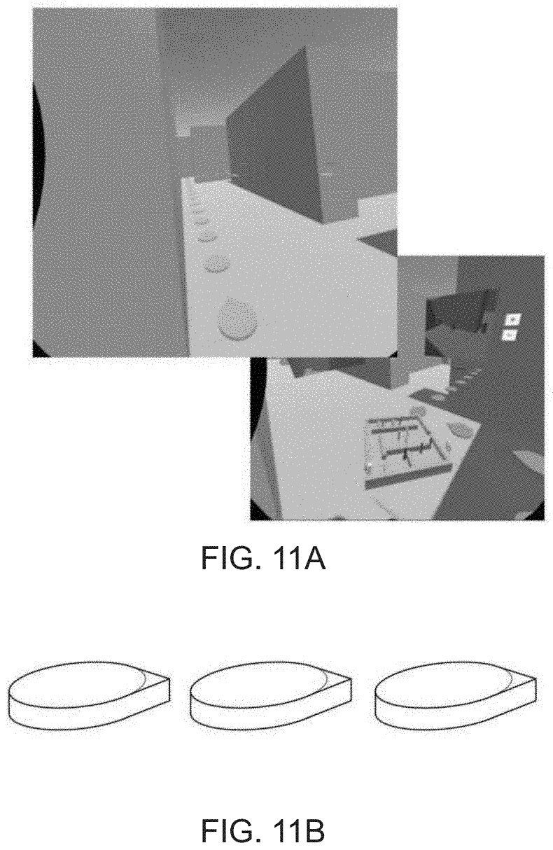

FIGS. 11A and 11B are illustrations showing an example of a navigation tool. Specifically, a path can be displayed as sequential steps. The sequential steps (hereafter referred to as “breadcrumbs”) can use an icon similar to the foot trackers icon, but smaller in size. The origin of a navigation can be a current position of the user. Different colors can be used to indicate different paths. Breadcrumbs can further be used to display a hypothetical/possible path. For example, the user can select a location, such as an exit, and breadcrumbs can indicate a path from the user to the location. The user can modify the path based on user preferences. For example, the user can select a shortest path, a safest path, a path that avoids a certain area, etc.

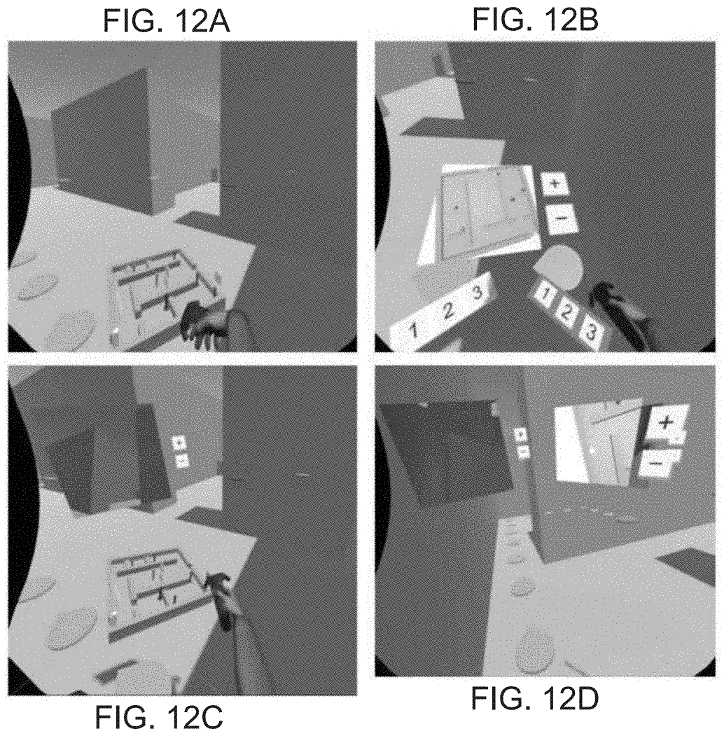

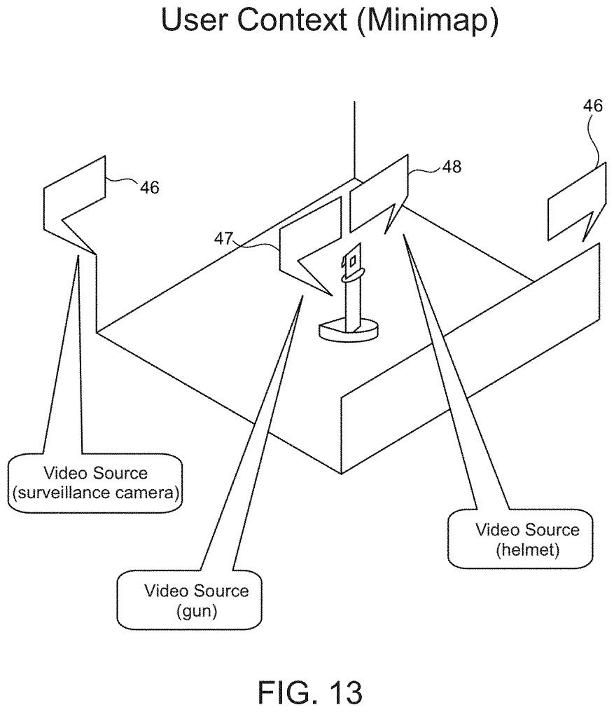

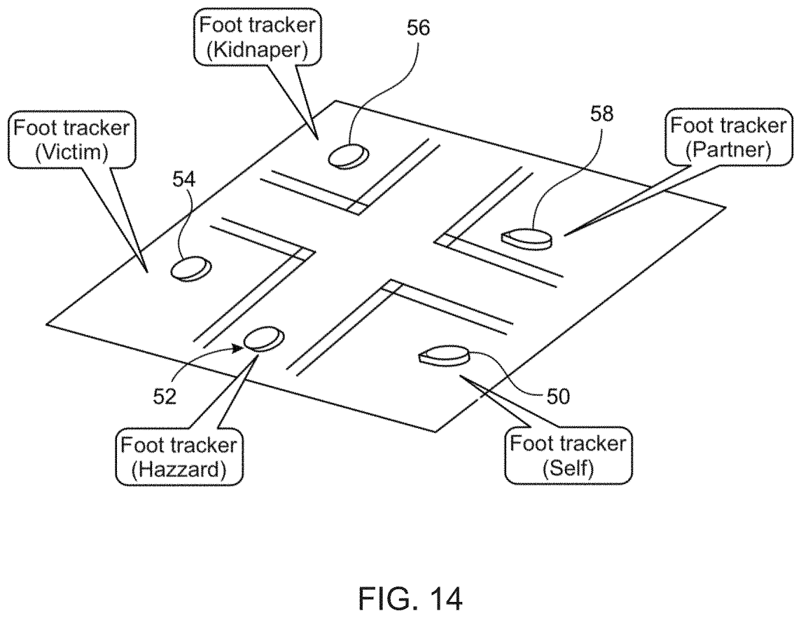

FIGS. 12A-12D are an illustration showing an example of a mini map tool. The mini map tool can show a 2D or 3D virtual representation or a virtual map of an environment where an incident is taking place. For example, the virtual environment can be one which the user is currently exploring, or a different virtual environment. The user can zoom in/out of the mini map, view foot trackers, navigational paths, view avatars, interact with the objects in the mini map, etc. For example, the user can see a person or a further user in the mini map as either a foot tracker or an avatar, interact on the representation of the person or user, and be presented with further options, such as an ID, biometrics, etc. FIG. 13 is another illustration showing an example of a mini map. Specifically, two people are shown in mini map. A first person has a first video source 46 and a second person has a second video source 47 and a third video source 48, such as, for example, video streaming from a camera on the second person's gun and from a camera on the second person's helmet. FIG. 14 is an illustration showing an example of a mini map with five different colored foot trackers. Specifically, FIG. 14 shows a user foot tracker 50, a hazard foot tracker 52, a victim foot tracker 54, a kidnapper foot tracker 56, and a partner foot tracker 58.

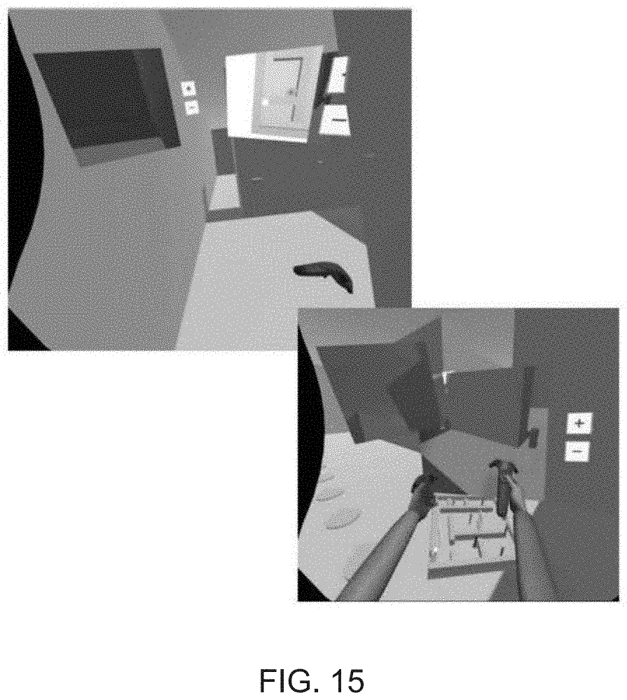

FIG. 15 is an illustration showing an example of a video feed tool. The video feed tool allows a user to view one or move video sources. The video source can be a live source or a recorded source. In a first example, a user can walk through a scene and select a video feed of a surveillance camera or an object camera. In a second example, a user can pull a live feed of a person walking in an area, such as, for example, an officer walking though the crime scene, an accident scene, an emergency situation, etc.

Other examples of tools include a rear-view mirror tool, a voice communication tool, a biometric tool, and a dashboard tool. A rear-view mirror tool can take a panoramic view from the user's HMD, can provide a view from the back of the head/neck, and can identify known objects and filter out the known objects against unknown objects by highlighting the unknown object. The voice communication tool can provide real-time, two-way communication between the user and one or more further users (e.g., operators). The biometric tool can subscribe biometric data from other operators. For example, biometrics can be collected from one or more sensors on the equipment of the user and the other operators. The biometric data includes body temperature, heart rate, wound areas, etc. The biometric tool can then subscribe each operator's collected biometric data and allow the user to access the biometric data via, for example, the mini map. The dashboard provides an ability to identify one or more metrics of interest to the user/operators, and to place these metrics on a dashboard for the user to view. The dashboard is a specific type of widget. The user can select one or more metrics via voice commands, equipment interaction, or through an administrative console on, for example, a computer or a smartphone. The metrics include, but are not limited to, a number of operators at a scene, a room temperature, an ammunition count, an oxygen level, a current time, etc.

### Operational Examples

The following operational examples illustrate example uses of the system described above. It should be understood that the operational examples are not limiting, and that the system described in the present disclosure can be used in any type of scenario.

In an example, a first user (a commander) and multiple other users (operators, such as SWAT officers) can be outfitted with one or more devices of the user equipment. The operators can have an augmented reality view on their HMD, where the operators can select widgets from a grid. The widgets can aid in a planning mode of an operation, an execution mode of an operation, etc. During each mode, the widgets on, for example, the helmet grid and the torso grid can be different. For example, during the planning mode, the grid can have a first set of widgets that are associated with contextual tools to aid the operators in understanding the situation, develop tactics, etc. During the execution mode, the grid can have a second set of widgets that are associated with critical information and tools which can aid in a breach.

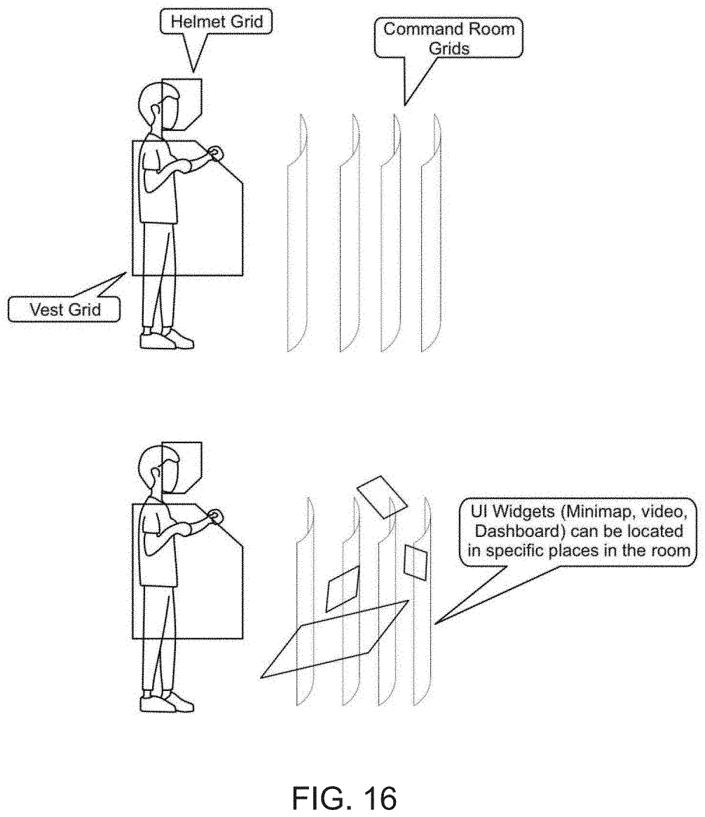

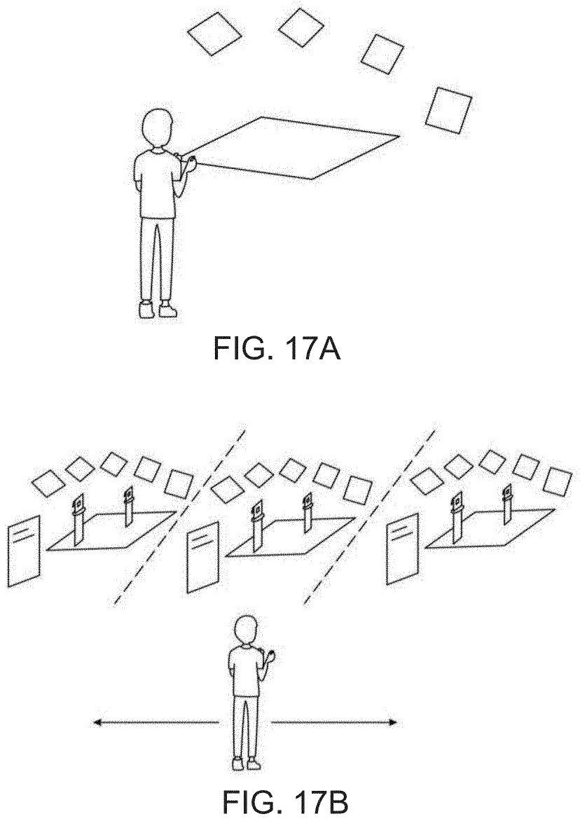

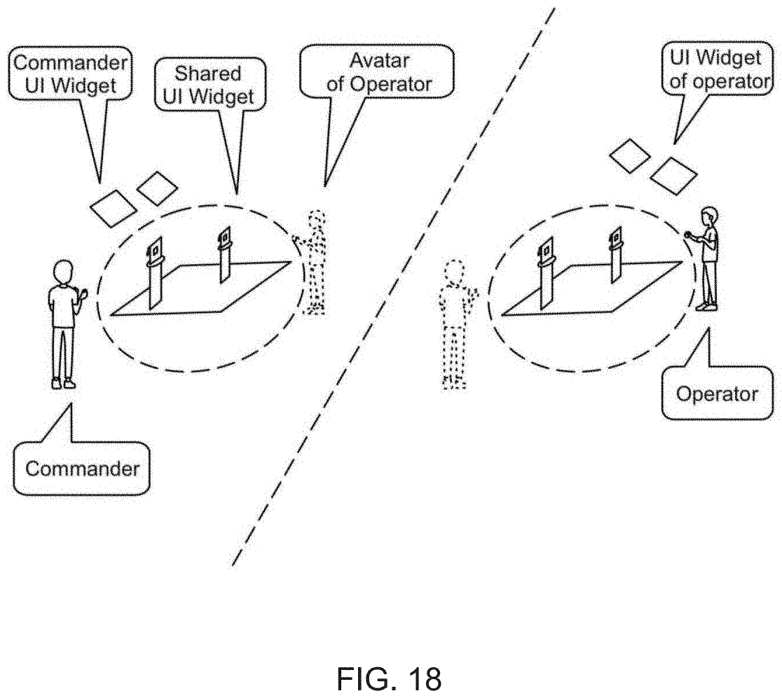

The commander can be in an observation mode, and the commander's grid can include widgets for observing and relating critical information to the operators. FIG. 16 illustrates examples of a commander's grid. Further, the commander can oversee a single location or multiple locations, as illustrated in FIGS. 17A and 17B. FIG. 18 is an illustration showing collaboration between a commander and an operator.

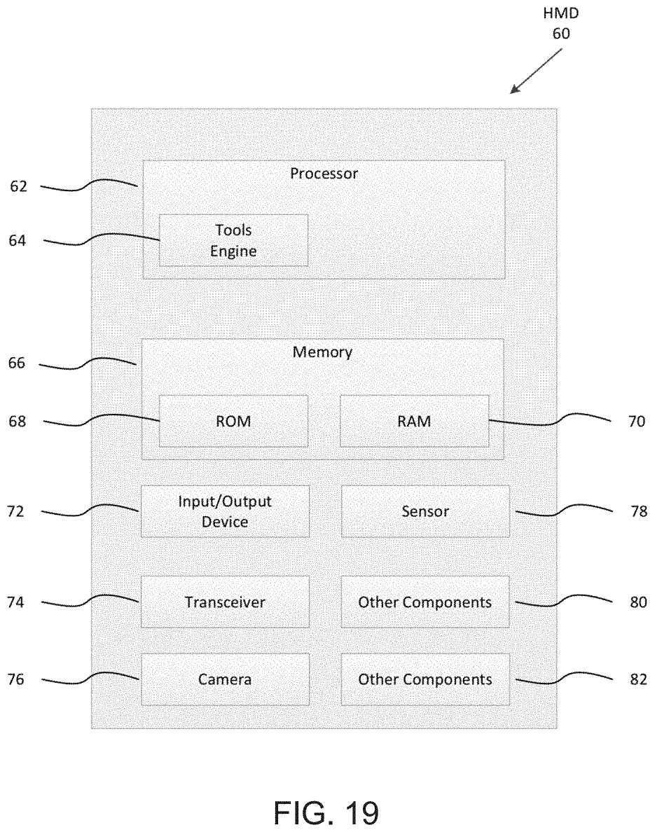

FIG. 19 is a diagram illustrating a HMD 60. It should be understood that the HMD 60 is by way of example for illustrative purposes only, and that other configurations can be used. The HMD 60 includes a processor 62, a memory 66, an input/output device 72, a transceiver 74, a camera 76, a sensor 78, and other components 80. The processor 62 can be configured to execute one or more applications or engines of the HMD 60. For example, the applications/engines can include tools engine 64, a WiFi connecting application, a Bluetooth connection application, a recording application, a sensor enabling application, etc. The tools engine 64 can include, for example, a route planner/evaluator engine to determine possible paths from one point to another and to evaluate the cost of each path based on multiple attributes and a relative weight of the attributes.

The memory 66 can be a hardware component configured to store data related to operations performed by the HMD 60. Specifically, the memory 66 can store video and sensor data. The memory can include any suitable, computer-readable storage medium such as a disk, non-volatile memory 68 (e.g., read-only memory (“ROM”), erasable programmable ROM (“EPROM”), electrically-erasable programmable ROM (“EEPROM”), flash memory, field-programmable gate array (“FPGA”), etc.), volatile memory 70, (e.g., random access memory (“RAM”), dynamic random-access memory (“DRAM”), etc.) or other types of storage mediums. The input/output device 72 is a hardware component that enables a user to enter inputs and display results, such as a hands device, a torso device, a waist device, a HUD, etc.

The transceiver 74 is a hardware component configured to transmit and/or receive data. The transceiver 74 can be a WiFi transceiver that enables communication with other electronic devices directly or indirectly through a WiFi network based upon the operating frequency of the WiFi network, a Bluetooth transceiver that enables communication with other electronic devices directly or indirectly through a Bluetooth connection based upon the operating frequency of the Bluetooth wireless technology standard, a cellular transceiver that enables communication with other electronic devices directly or indirectly through a cellular connection based on the operating frequency of LTE/legacy/5G, cellular technology, or any other suitable transceiver.

The camera 76 can be one or more cameras discussed above, such as, but not limited to, a live feed camera, a night vision camera, a thermal camera, an infrared camera, a 3D scanning camera, etc. The sensor 78 can be one or more sensors discussed above, such as, but not limited to, heat sensors, chemical sensors, humidity sensors, pressure sensors, audio microphones, speakers, depth sensors, or any other sensors capable of determining or gathering data. The other components 80 can include a display device such a screen, a touchscreen, etc., a battery, a power port/cable, an audio output device, an audio input device, a data acquisition device, a USB port, one or more further ports to electronically connect to other electronic devices, etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is intended to be protected by Letters Patent is set forth in the following claims.

1. A system for generating user interface (“UI”) elements in a virtual environment, comprising:
a head device worn by a user, the head device displaying the virtual environment for the user;
at least one wearable device worn by the user; and
a processor in communication with the head device and the at least one wearable device, the processor generating a persistent virtual toolkit including at least one UI element corresponding to the at least one wearable device worn by the user, and causing the head device to display the persistent virtual toolkit in the virtual environment, the persistent virtual toolkit movable in the virtual environment by the user to a desired location within the virtual environment, the virtual toolkit persisting at the desired location while the user moves within the virtual environment.

2. The system of claim 1, wherein the virtual toolkit further comprises:
a first UI area is associated with the head device, the first UI area including a first magnet grid and the first magnet grid comprises a first group of magnets,
wherein the magnets provide positional information relating to a location where the at least one UI element can be attached.

3. The system of claim 2, wherein the virtual toolkit further comprises:
a second UI area associated with the at least one wearable device worn by the user, the second UI area including a second magnet grid and the second magnet grid comprises a second group of magnets.

4. The system of claim 3, wherein the first magnet grid is defined using a first set of parameters and attributes, and the second magnet grid is defined using a second set of parameters and attributes.

5. The system of claim 1, wherein the user interacts with the at least one UI element using a hand gesture, a voice command, an eye command, a controller, or a sensor.

6. The system of claim 1, wherein the at least one UI element comprises at least one of a video, a floorplan, a tool, a sensor, evidence, or a defined area where a user can perform a hand gesture.

7. The system of claim 1, wherein the at least one UI element comprises a menu of buttons.

8. The system of claim 1, further comprising:
a second wearable device in communication with the processor, wherein the processor;
generates a second UI element corresponding to the second wearable device, the second UI element forming part of the virtual toolkit; and
causes the head device to display the second UI element in the virtual environment.

9. The system of claim 1, wherein the at least one wearable device comprises a device worn on a user's torso, waist, arm, wrist, or hand.

10. The system of claim 1, wherein the head device comprises one of a head-mounted display, virtual reality glasses, or smart glasses.

11. The system of claim 1, wherein the head device or the at least one wearable device comprises at least one of a live feed camera, a night vision camera, a thermal camera, an infrared camera, or a 3D scanning camera.

12. The system of claim 1, wherein the head device comprises at least one of a microphone, a speaker, a heat sensor, a chemical sensor, a humidity sensor, a pressure sensor, or a depth sensor.

13. The system of claim 1, wherein the virtual environment comprises one of a virtual reality environment, an augmented reality environment, or a mixed reality environment.

14. The system of claim 1, wherein the virtual toolkit further comprises a tracker for indicating a type of device, and the processor causes the head device to display the tracker in the virtual environment.

15. The system of claim 1, wherein the virtual toolkit further comprises a navigational tool capable of indicating a physical path travelled by a user, the path including at least one of an actual path, a possible path, or a hypothetical path; and the processor causes the head device to display the path as a series of sequential steps in the virtual environment.

16. The system of claim 1, wherein the virtual toolkit further comprises a mini map tool showing a 2D or a 3D virtual representation or a virtual map of an environment where an incident is occurring; and the processor causes the head device to display the mini map tool in the virtual environment.

17. The system of claim 16, wherein the mini map tool displays one or more trackers.

18. The system of claim 1, wherein the virtual toolkit further comprises a video feed tool streaming a live view or a recording from a camera associated with another user, an object, or a surveillance camera; and the processor causes the head device to display the video feed tool in the virtual environment.

19. The system of claim 1, wherein the virtual toolkit further comprises at least one of a rear-view mirror tool, a voice communication tool, a biometric tool, or a dashboard tool.

20. The system of claim 1, wherein the desired location is set relative to the user or set relative to the virtual environment.

21. A method for generating user interface (“UI”) elements in a virtual environment, comprising the steps of:
displaying the virtual environment in a head device worn by a user;
generating a persistent virtual toolkit by a processor in communication with the head device and at least one wearable device worn by the user, the persistent virtual toolkit including at least one UI element corresponding to the at least one wearable device;
displaying the persistent virtual toolkit in the virtual environment;
allowing the user to move the persistent virtual toolkit to a desired location within the virtual environment; and
maintaining the persistent virtual toolkit at the desired location while the user moves within the virtual environment.

22. The method of claim 21, wherein the step of generating the virtual toolkit further comprises generating a first UI area is associated with the head device, the first UI area including a first magnet grid and the first magnet grid comprises a first group of magnets, wherein the magnets provide positional information relating to a location where the at least one UI element can be attached.

23. The method of claim 22, wherein the step of generating the virtual toolkit further comprises generating a second UI area associated with the at least one wearable device worn by the user, the second UI area including a second magnet grid and the second magnet grid comprises a second group of magnets.

24. The method of claim 23, wherein the first magnet grid is defined using a first set of parameters and attributes, and the second magnet grid is defined using a second set of parameters and attributes.

25. The method of claim 21, further comprising the step of generating a second UI element corresponding to a second wearable device, the second UI element forming part of the virtual toolkit, and displaying the second UI element in the virtual environment.

26. The method of claim 21, further comprising displaying in the head device at least one of a live feed camera, a night vision camera, a thermal camera, an infrared camera, or a 3D scanning camera.

27. The method of claim 21, further comprising generating a tracker for indicating a type of device, and displaying the tracker in the virtual environment.

28. The method of claim 21, further comprising generating a navigational tool capable of indicating a physical path travelled by a user, the path including at least one of an actual path, a possible path, or a hypothetical path; and displaying the path in the head device as a series of sequential steps in the virtual environment.

29. The method of claim 21, wherein the desired location is set relative to the user or set relative to the virtual environment.

30. The method of claim 21, further comprising generating a mini map tool showing a 2D or a 3D virtual representation or a virtual map of an environment where an incident is occurring; and displaying the mini map tool in the virtual environment in the head device.

31. The method of claim 30, wherein the mini map tool displays one or more trackers.

32. The method of claim 21, further comprising generating a live video feed tool streaming a live view from a camera associated with another user; and displaying the live video feed tool in the virtual environment in the head device.

33. The method of claim 21, wherein the step of generating the virtual toolkit further comprises generating at least one of a rear-view mirror tool, a voice communication tool, a biometric tool, or a dashboard tool.
